(19) United States
(12) Patent Application Publication
(10) Pub. No.: US 2010/0131924 A1
(43) Pub. Date: May 27, 2010

(54) METHOD OF BUILDING VIRTUAL KEYBOARD

(75) Inventor: TENG-YU TSAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/463,474

(22) Filed: May 11, 2009

(30) Foreign Application Priority Data
Nov. 26, 2008 (CN) 200810305733.0

(51) Int. Cl. G06F 3/048; G06F 9/44

(52) U.S. Cl. 717/110; 715/773; 719/318

(57) ABSTRACT

A method of building and using of a virtual keyboard program that includes programming a virtual keyboard program by a scripting language programming tool is disclosed. The method includes registering an allowable execution action of a web browser to the virtual keyboard, such that the virtual keyboard is capable of being freely executed in the web browser based on scripting language. An event listener is used to monitor inputting actions.

### BACKGROUND

1. Technical Field

The present disclosure relates to a method of building virtual keyboards, especially to a method of building an on-screen virtual keyboard.

2. Description of Related Art

Virtual keyboards are broadly used in computers for many reasons. For example, virtual keyboard may be used in some cases to reduce the risk of keystroke logging. Although it is technically possible for malware to monitor the display and mouse to obtain the data entered via the virtual keyboard, it is significantly harder than monitoring real keystrokes. In addition, virtual keyboards can be conveniently used in some portable electronic devices to replace real keyboards, to reduce the overall volume and make best use of the screen of portable electronic devices.

Present virtual keyboard programs are usually structured on one graphic library, such as GIMP Toolkit (GTK), or QT, and etc. When a virtual keyboard program structured by one graphic library, such as GTK, it can only be used in one kind of programs which fully support the GTK. However, when the keyboard program cannot be used in other kinds of programs, and the original codes of the virtual keyboard program must be amended or reconstructed by a supported graphic library again.

What is needed, therefore, is a method of building an on-screen virtual keyboard based on web browsers.

### BRIEF DESCRIPTION OF THE DRAWINGS

FIG. 1 is a block view of an embodiment of showing a develop module of a virtual keyboard.

FIG. 2 is a block diagram of the embodiment showing the method of building the virtual keyboard.

FIG. 3 is a view in application of the virtual keyboard.

### DETAILED DESCRIPTION

In the embodiment, a scripting language programming tool is used for building a virtual keyboard in a web browser to allow some control of a single or many software application(s). JAVASCRIPT® is one of the scripting languages used to enable programmatic access to objects within other applications.

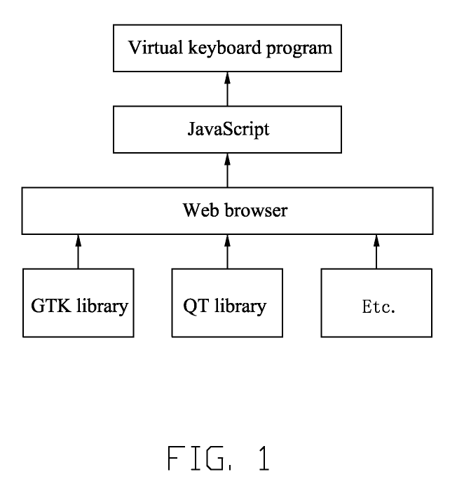

Referring to FIG. 1, the virtual keyboard program is built by a scripting language programming tool, which can be supported by most web browsers. The virtual keyboard program is used in the web browsers and can access any needed graphic library through the web browsers based on scripting language. The virtual keyboard program used in different web browsers may not need to amend its original codes.

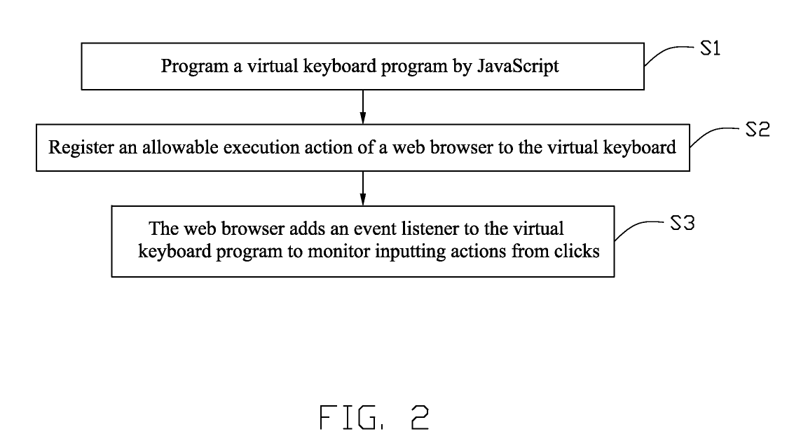

Referring to FIG. 2, in actual use, some browsers may block the scripting language to run, for safety reasons, across a client terminal to a web server. A method of building and usage of a virtual keyboard program includes the following steps:

S1: program a virtual keyboard program by a scripting language programming tool, wherein the step further includes: setup a layout of a virtual keyboard and define multiple keys; associate the keys to the real value; setup a user interface (UI) and a placement of the virtual keyboard;

S2: register an allowable execution action of a web browser to the virtual keyboard, such that the virtual keyboard can be freely executed in the web browser based on the scripting language; and

S3: the web browser adds an event listener to the virtual keyboard program to monitor inputting actions from clicks.

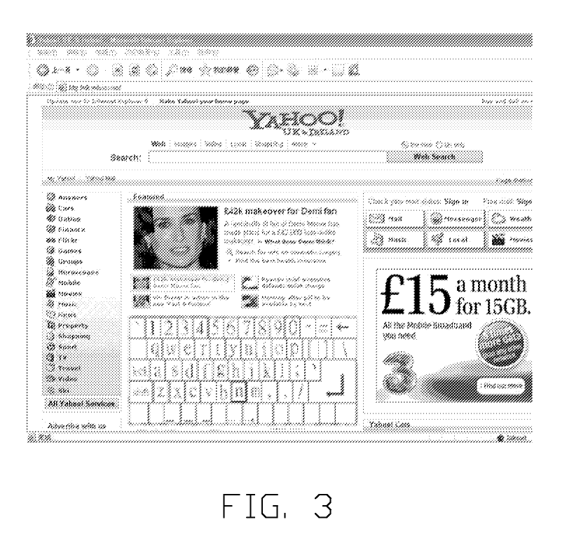

Referring to FIG. 3, an application of the virtual keyboard is shown. The virtual keyboard can be used in different kinds of web browsers by registering associated allowable execution actions. The virtual keyboard can be simply constructed by the scripting language programming tool, and size and display resolution of virtual keyboard can be easily adjusted. The design and the style of an interface of the virtual keyboard can be changed or adapted by other picture drawing tools. The virtual keyboard can also be adapted in an embedded operating system of an electronic device, such as a mobile phone, a digital media adapter (DMA), or a digital photo frame (DPF) etc.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A method of building and using of a virtual keyboard program comprising:
programming a virtual keyboard program by a scripting language programming tool;
registering an allowable execution action of a web browser to the virtual keyboard, such that the virtual keyboard is capable of being freely executed in the web browser based on scripting language; and
adding an event listener to the virtual keyboard program to monitor inputting actions.

2. The method of building and using of a virtual keyboard program of claim 1, wherein the step of programming a virtual keyboard program by the scripting language programming tool further comprises: setup a layout of a virtual keyboard and define multiple keys; associate the keys to the real value; and setup a user interface (UI) and a placement of the virtual keyboard.

3. The method of building and using of a virtual keyboard program of claim 1, wherein the virtual keyboard is used in an embedded system of an electronic device.
